(19) United States
(12) Patent Application Publication
(10) Pub. No.: US 2010/0201546 A1
(43) Pub. Date: Aug. 12, 2010

(54) Device for the Temporary Presentation of Data on a Viewing Screen

(75) Inventors: Denis Bonnet, Bordeaux (FR); Xavier Servantie, Pessac (FR); Nicolas Nides, Merignac (FR); Roland Tomczak, Toulouse (FR); Joél Viala, Toulouse (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly-Sur-Seine (FR)

(21) Appl. No.: 12/678,844

(22) PCT Filed: Aug. 28, 2008
(86) PCT No.: PCT/EP08/61284

§ 371 Date: Mar. 18, 2010

(30) Foreign Application Priority Data
Sep. 18, 2007 (FR) 0706555

(51) Int. Cl. G01C 23/00; G09G 5/00

(52) U.S. Cl. 340/971; 345/629

(57) ABSTRACT

The general field of the invention is that of the viewing devices used for the management of complex systems. The viewing device comprises the following functionalities:
the items of information of one and the same type are placed in a given plane;
the various planes are presented in superposition on the viewing screen;
the device comprises control means making it possible to select any one of said planes;
the selected plane is displayed in the foreground;
the unselected planes are displayed in the background, the intrinsic visibility of the items of information of said unselected planes being substantially diminished.

### PRIORITY CLAIM

This application claims priority to PCT Patent Application Number PCT/EP2008/061284, entitled Device for the Temporary Presentation of Data on a Viewing Screen, filed Aug. 28, 2008, also claiming priority to FR 07 06555, filed Sep. 18, 2007.

### FIELD OF THE INVENTION

The technical field of the invention is that of the presentation of data on viewing screens. The invention applies more particularly to the aviation field.

### BACKGROUND OF THE INVENTION

In a certain number of industrial applications, it is necessary to present to a user a great amount of information in order to manage, supervise or control a complex system. In the aviation field notably, the continued progress of the onboard electronics and of the associated systems makes it possible to present to the crew a very large number of items of information concerning piloting, navigation or the craft itself. Mention will notably be given to the items of cartographic information or the items of information called ASAS, the acronym for “Aviation Safety Analysis Subsystem”. These items of information are presented on viewing screens placed on the instrument panel in front of the crew. In order to select, modify or delete information, the pilot uses man-machine interfaces that are conventionally a computer “pointer” connected to a designator. This designator is usually of the computer “mouse” type. It is also possible to use touch screens in order to perform the same functions or control keyboards.

The quantity of information proposed is such that it is no longer possible to present a single set of information of a given type on a dedicated screen. It is necessary to present several sets of information of different types on one and the same screen. For example, a screen of tactical information used in aircraft cockpits presents many sources of information which are superposed. Mention will be made notably of:
the relief of the terrain usually presented with shading;
the planimetric information such as roads, rivers, towns, etc;
the navigation information such as beacons, air routes, the flight plan of the craft;
the information on air traffic showing the other aircraft situated in its vicinity,
the weather information.

In order to manage these items of information, a first solution consists in displaying all of the available information. The system for managing the displays of AIRBUS A320 and A380 aircraft obeys this principle. A second solution consists in laying out the information on one and the same topic on one and the same level that is also called an “overlay”. The user can make certain overlays visible or invisible. This solution is adopted in most of the current avionic solutions. For example, the user can decide to display or remove the overlays relating to cartography or the weather radar information.

A more sophisticated solution consists in defining, for certain overlays, the nature of the information displayed, by using a menu. For example, on the overlay dedicated to the monitoring of the flight plan, also called the “FMS” for “Flight Management System”, it is possible to decide to display the airport zones. This solution is developed by Honeywell and used by Dassault under the EASy brand.

These solutions however have certain drawbacks. When the user wishes to have more detailed information on one of the overlays, for example the times of arrival at the waypoints of the flight plan, he has to go to the associated menu and request the display of these items of information. If the image is overloaded, for example when the cartography is also displayed, he must also request that the unnecessary information is masked, for example request the masking of toponym information of the cartography. Several operations are therefore necessary to obtain the sought information in a legible manner. To view this sought information correctly, certain other items of information must be totally masked.

### SUMMARY OF THE INVENTION

The invention is situated in the field of tactical information display systems in the context of aircraft cockpits. The object of the invention is to provide a simple mechanism for making it possible to display additional information without, nevertheless, compromising the overall legibility of the information that is already present.

More precisely, the subject of the invention is a viewing device for the management of a system comprising at least means for generating and displaying on a viewing screen information of at least two different types relating to the system and means for controlling said displays, characterized in that:
the items of information of one and the same type are placed in a given plane (L1, L2, L3);
the various planes are presented in superposition on the viewing screen;
the control means make it possible to select any one of said planes;
the selected plane is displayed in the foreground;
the unselected planes are displayed in the background, the intrinsic visibility of the items of information of said unselected planes being substantially diminished.

Advantageously, the reduction of visibility is obtained by reducing the contrast or the brightness of these items of information.

Advantageously, all the items of information contained in the selected plane are displayed and the selection of the planes takes effect only for the period of action of a user on the control means or only during a transitional period.

Preferably, the system is a flight-management system for an aircraft, the information relates to the piloting or navigation of said aircraft and the display means are the instrument panel displays.

### BRIEF DESCRIPTION OF THE DRAWINGS

The invention will be better understood and other advantages will appear on reading the following description given as a nonlimiting description and by virtue of the appended figures amongst which:

FIG. 1 represents an example of three information planes to be displayed;

FIGS. 2 and 3 represent the display of these various planes according to the prior art;

FIGS. 4 and 5 represent a first mode of displaying the previous planes according to the invention;

FIGS. 6 and 7 represent a second mode of displaying the previous planes according to the invention.

### MORE DETAILED DESCRIPTION

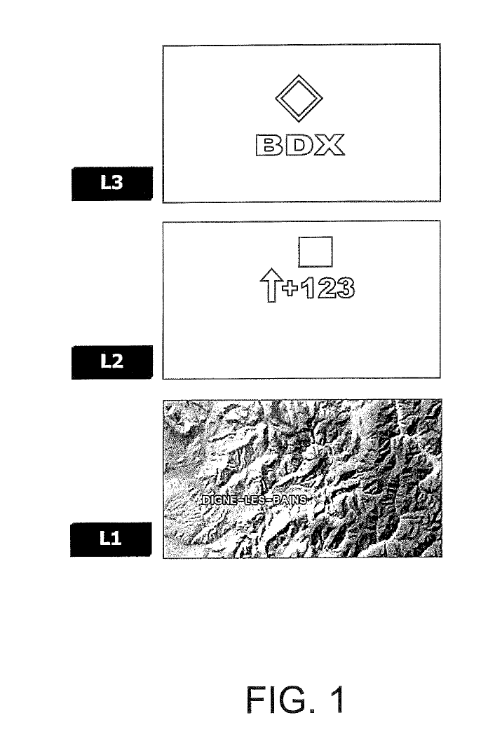

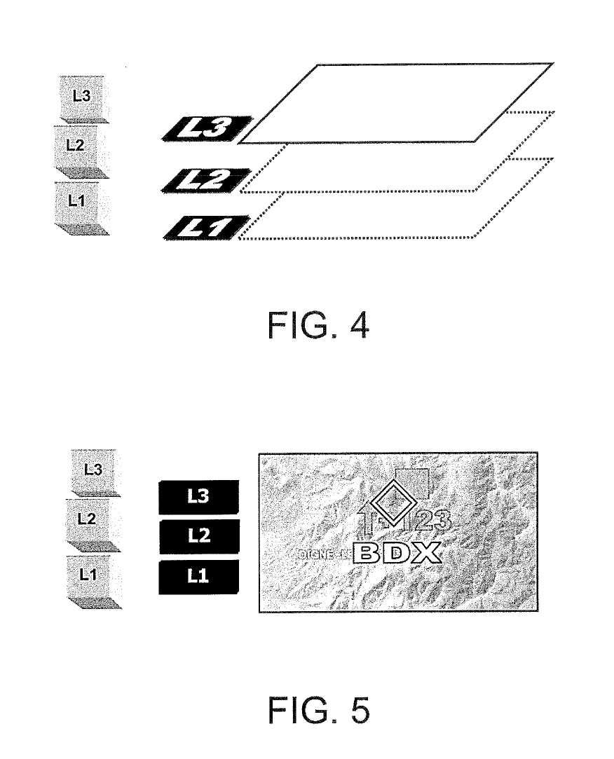

To illustrate the device according to the invention, FIGS. 1 to 3 represent, in the context of an aviation application, an exemplary application according to the prior art and FIGS. 4 to 7 represent the same example in two configurations according to the invention. The images are represented in black and white or in shades of gray in these various figures. On the cockpit display screens, these figures are naturally shown in color.

FIG. 1 represents an example of three extracts of information planes to be displayed on a navigation screen, the planes being marked L1, L2 and L3 in the various figures. They are also called “overlays”.
L1 represents conventionally a cartographic image seen from above with shading, with the town of Digne-les-Bains in France marked.
L2 represents the other aircraft situated in the environment close to the aircraft. On the plane L2 of FIG. 1, the aircraft “123” is represented by a white square symbol, the arrow indicating the fact that it is descending.
L3 represents the flight plan. On the plane L3 of FIG. 1, the airport code for the city of Bordeaux in France is represented by a white diamond accompanied by the letters “BDX”.

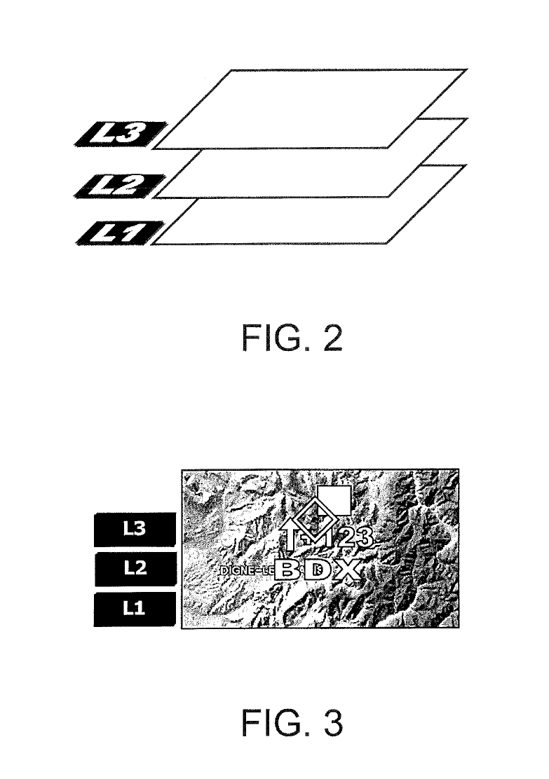

Conventionally, as has been said and as illustrated in FIGS. 2 and 3, the three planes are displayed simultaneously. As can be seen in FIG. 3, the information that overlaps becomes largely illegible.

In the device according to the invention, the display can be controlled by control means. These control means may be real buttons placed on the keyboards or control stations or can be virtual and represented in the form of icons on the display screen. In the latter case, they are controlled by a designator of the computer “mouse” type, for example. Each button is associated with an overlay. While the user holds the button, the system is in a new mode called “X-Ray”, which it leaves as soon as the user releases the button. This mode is characterized by the following features:
it is temporary;
it places in the foreground the overlay with which the button is associated;
it displays all the additional information required. For example, it displays the predicted times of arrival at the waypoint of the flight plan;
it temporarily and partially masks the other overlays. These overlays remain visible but are attenuated, the intrinsic visibility of the information of said unselected planes being substantially reduced, for example by reducing either the intrinsic contrast, or the brightness of the unselected overlays.

Usually, the pixels forming an image are characterized by four parameters. The first three parameters correspond conventionally to the colorimetric coordinates and the fourth to a coefficient of transparency marked α. By reducing simultaneously the first three parameters by one and the same factor, the user reduces the value of the brightness of the pixel. By working on the value of α, it is easy to reduce or increase the contrast of the overlays.

FIGS. 4 to 7 show the application of the device according to these arrangements. In this case, the device therefore comprises three control buttons corresponding to the overlays L1, L2 and L3. These buttons are shown on the left of the figures.

In FIGS. 4 and 5, the button L3 is activated. It is shown pressed in. The overlay L3 representing the flight plan is placed in the foreground and the overlays L1 and L2 move to the background, the contrast of these overlays being substantially reduced. The information of L3 becomes clearly visible. When the user ceases to hold down the button L3, the system returns to the previous interface. It can also return to the previous interface at the end of a predetermined time, which can be of the order of a few seconds.

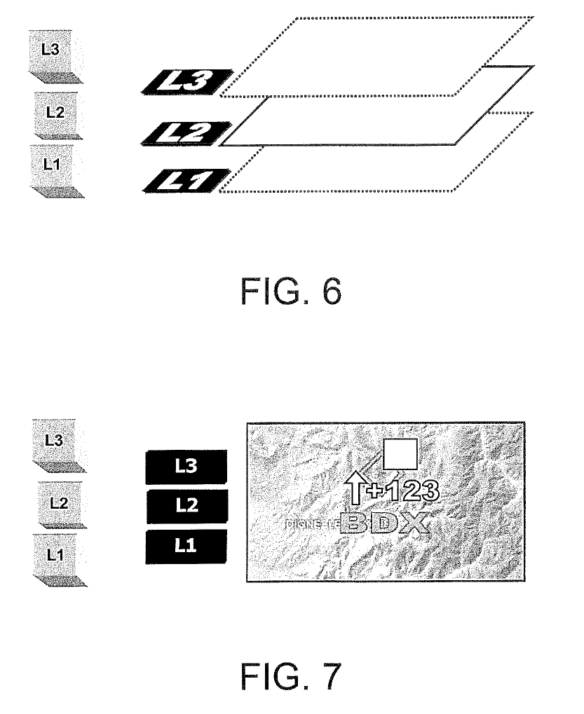

In FIGS. 6 and 7, the button L2 is activated. It is shown pressed in. The overlay L2 representing the other aircraft situated in the environment near to the aircraft is placed in the foreground and the overlays L1 and L3 move to the background, the contrast of these overlays being substantially reduced. The information of L2 becomes clearly visible. It should be noted that the activation of L2 could also be accompanied by the display of additional information on the overlay L2, for example the name of the airlines. When the user ceases to hold down the button L2, the system returns to the previous interface.

In order to promote the continuity of the mental representation of the user, the switch between the standard view and the “X-ray” view can be carried out through a progressive transition, in particular a progressive transition on the value of the coefficient α between its standard state and its attenuated state.

In addition to making it possible to clearly view an item of information that could not normally be clearly viewed, this innovation can also allow the users to view an object much more easily. For example, in the case of a traffic warning indicating a nearby airplane, pressing the button associated with traffic will make it possible to identify the position of the dangerous airplane much more quickly.

What is claimed is:

1. A viewing device for the management of a system comprising at least means for generating and displaying on a viewing screen information of at least two different types relating to the system and means for controlling said displays, wherein:
the items of information of one and the same type are placed in a given plane;
the various planes are presented in superposition on the viewing screen;
the control means make it possible to select any one of said planes;
the selected plane is displayed in the foreground;
the unselected planes are displayed in the background, the intrinsic visibility of the items of information of said unselected planes being substantially diminished;
the selection of the planes takes place only for a transitional period or only during the period of action of a user on the control means

2. The viewing device as claimed in claim 1, wherein the reduction of visibility of the items of information of the planes is obtained by reducing the contrast or the brightness of these items of information.

3. The viewing device as claimed in claim 1, wherein all the items of information contained in the selected plane are displayed.

4. The viewing device as claimed in claim 1, wherein the system is a flight-management system for an aircraft, that the information relates to the piloting or navigation of said aircraft and that the display means are the instrument panel displays.
